(19) United States
(12) Patent Application Publication
(10) Pub. No.: US 2020/0183650 A1
(43) Pub. Date: Jun. 11, 2020

(54) RADIX-1000 DECIMAL FLOATING-POINT NUMBERS AND ARITHMETIC UNITS USING A SKEWED REPRESENTATION OF THE FRACTION

(71) Applicant: KING FAHD UNIVERSITY OF PETROLEUM AND MINERALS, Dhahran (SA)

(72) Inventor: Muhamed Fawzi MUDAWAR, Dhahran (SA)

(73) Assignee: KING FAHD UNIVERSITY OF PETROLEUM AND MINERALS, Dhahran (SA)

(21) Appl. No.: 16/214,925

(22) Filed: Dec. 10, 2018

(51) Int. Cl. G06F 7/491; G06F 7/508

(52) U.S. Cl. CPC G06F 7/4912; G06F 2207/4911; G06F 7/508

(57) ABSTRACT

A system, structure and method using radix-1000 (instead of radix-10) are implemented to represent and operate on decimal floating-point numbers. Instead of using a 10-bit declet to encode a DPD, the system, structure and method herein use a declet to encode a BCK (Binary Coded 1000 values), where the letter K is the abbreviation of the number 1000. A skewed representation of the fraction field is then used to avoid the loss of decimal digits in arithmetic operations when shifting and rounding the fraction are required.

### SUMMARY

### Field of the Invention

This invention relates to the field of computer arithmetic. More precisely, it relates to radix-1000 decimal floating-point numbers of various sizes (32 bits, 64 bits, and 128 bits) that use a skewed representation of the fraction to maintain precision and accurate arithmetic on decimal floating-point numbers. It also relates to the implementation of radix-1000 floating point arithmetic units in a method, system and/or computer program product capable of use of floating point arithmetic units for calculation and processing.

### DISCUSSION OF THE RELATED ART

The IEEE 754-1985 standard was established for binary floating-point numbers. See David Stevenson, et al., “IEEE Standard for Binary Floating-Point Arithmetic”, IEEE Std 754-1985, March 1985, incorporated herein by reference in its entirety. The widely adopted 1985 standard defined the format and encoding of single, double, and extended-precision binary floating-point data that included normal and subnormal numbers, signed zeros, signed infinites, and special “not a number” (NaN) values. The 1985 standard defined arithmetic, conversion, comparison operations, rounding rules, special arithmetic on signed zeros, infinities, and NaNs. The major drawback of binary floating-point numbers is its inability to represent decimal fractions (such as 0.2) exactly in binary. The binary fraction must be rounded to the required precision.

The more recent IEEE 754-2008 standard (D. Zuraz, M. Cowlishaw, et al., “IEEE Standard for Floating-Point Arithmetic”, IEEE Std 754-2008, August 2008, incorporated herein by reference in its entirety) extended the original IEEE 754-1985 by adding decimal floating-point numbers. The need for decimal floating-point is important for financial applications, such as banking, taxes, and currency conversions. The use of binary floating-point numbers is inadequate for such applications because of rounding errors, which can be significant in some applications. See M. Cowlishaw, “Decimal Floating-Point: Algorism for Computers”, 16^{th} IEEE Symposium on Computer Arithmetic (ARITH'03), p. 104-111, June 2003, incorporated herein by reference in its entirety.

Although the IEEE 754-2008 decimal floating-point standard can represent decimal fractions exactly with finite precision, the decimal format is complex. The format has three fields: a sign bit, a combination field, and a coefficient continuation field. The coefficient continuation field uses 10-bit declets to encode Binary Code Decimal (BCD) digits. This encoding scheme is known as Densely Packed Decimal (DPD). See M. Cowlishaw, “Densely Packed Decimal Encoding”, IEE Proceedings—Computers and Digital Techniques, vol. 149, p. 102-104, May 2002, incorporated herein by reference in its entirety. Each declet requires logic to unpack the three BCD digits and then pack them at the end of each operation. See Id.; and S. Carlough, A. Collura, S. Mueller, and M. Kroener, “The IBM zEnterprise-196 decimal floating-point accelerator”, in Proceedings of the 20^{th} IEEE Symposium on Computer Arithmetic, Germany, p. 139-146, July 2011, incorporated herein by reference in its entirety. Internally, the decimal floating-point unit uses BCD digits in arithmetic operations. This is inefficient and increases the area of the decimal floating-point unit in comparison with a binary floating-point unit.

Decimal floating-point numbers are based on the IEEE 754-2008 standard. See D. Zuraz, M. Cowlishaw, et al., “IEEE Standard for Floating-Point Arithmetic”, IEEE Std 754-2008, August 2008, incorporated herein by reference in its entirety. The standard defines decimal interchange formats, called decimal32, decimal64, and decimal128, of widths 32, 64, and 128 bits, respectively. The format has three fields: a sign bit, a combination field, and a coefficient continuation field, as shown in FIG. 1. The combination field has 5+w bits that encode the leading digit of the integer coefficient and the biased exponent E. It was defined this way to encode an extra leading digit in the coefficient and to maximize the exponent range. The coefficient continuation field has 10×k bits (k declets) that encode 3×k decimal digits in DPD.

The integer coefficient C consists of p decimal digits, where p is the precision: p=7, 16, and 34 for decimal32, decimal64, and decimal128, respectively. The numerical value of a finite decimal floating-point number is: (−1)^{s}×C×10^{q}, where q=E−Bias. Prior work on decimal-point numbers was led by the IBM zEnterprise decimal floating-point accelerator. See Id. Other work on the implementation of decimal-point operations and units are documented in L. K. Wang and M. J. Schulte, “Decimal Floating-Point Adder and Multifunction Unit with Injection-Based Rounding”, in Proceedings of the 18^{th} IEEE Symposium on Computer Arithmetic, France, June 2007; L. K. Wang, M. J. Schulte, J. D. Thompson, and N. Jairam, “Hardware designs for Decimal Floating-Point Addition and Related Operations”, IEEE Transactions on Computers, 58 (3), March 2009; L. K. Wang and M. J. Schulte, “A Decimal Floating-Point Adder with Decoded Operands and a Decimal Leading-Zero Anticipator”, in Proceedings of the 19^{th} IEEE Symposium on Computer Arithmetic, 2009; A. Wahba and H. Fahmy, “Area Efficient and Fast Combined Binary/Decimal Floating Point Fused Multiply Add Unit”, IEEE Transactions on Computers, Vol 66, No 2, February 2017, p. 226-239; and A. Vazquez, E. Antelo, and P. Montuschi, “Improved Design of High-Performance Parallel Decimal Multipliers”, IEEE Transactions on Computers, Vol 59, No 5, May 2010, p. 679-693, each incorporated herein by reference in its entirety. All of this work is based on the IEEE 754-2008 standard.

However, as noted above, even the revised IEEE 754-2008 standard uses Radix 10 for representing decimal floating-point numbers and for decimal floating-point arithmetic. IBM has implemented Radix-10 Floating-point units inside their recent processors. In contrast, as will be explained further hereinbelow, the present invention introduces a novel representation of FLOATING-POINT numbers based on radix-1000 and a SKEWED representation of the fraction. The invention also presents detailed implementation of floating-point arithmetic units that can be of various sizes (32-bit, 64-bit, and 128-bit).

U.S. Pat. No. 7,644,115 B2 is directed to systems and methods for performing large-radix numeric operations. A first number may be segmented into large-radix segments, wherein numbers of the segments are generated such that radix of the segment is greater than radix of the first number. As a result, a plurality of disparate processor-based computing systems may be configured to perform various numeric operations on the large-radix segments of the number and output results of a numeric operation as a number whose radix is equal to the radix of the first number.

In U.S. Pat. No. 7,644,115 B2 unlike the present invention, the numbers that are manipulated are fixed-point numbers that might include a fraction; they are not floating-point numbers. There is no exponent field; there is no format for the number itself (just a string of characters); and there is no hardware implementation. As will be explained further hereinbelow, the present invention incorporates features such as using 32 bits, 64 bits, and 128 bits to store a radix-1000 decimal floating-point number in binary with an exponent field and a skewed representation of the fraction, none of which are present in this prior art. Instead, U.S. Pat. No. 7,644,115 B2 discloses the use of segmentation instructions to segment large numbers and requesting the operating system to store large-radix numbers and segments in a data structure (arrays, lists, etc.).

U.S. Pat. No. 6,546,411 B1 is directed to a high-speed radix 100 parallel adder that provides an improved method and apparatus for performing decimal arithmetic using conventional parallel binary adders. In a first aspect, a method for implementing decimal arithmetic using a radix (base) 100 and a method for implementing radix 1000 numbering system are disclosed. The first aspect implements decimal arithmetic utilizing radix 100, where one-hundred decimal numbers, 0 through 99, are represented using seven BCD bits. In a second aspect, a specialized high-speed radix 100 parallel adder is disclosed. In effect, numbers are segmented into several large-radix segments. The radix of a segment may be 100, 1000, 10000, 100000, 1000000, etc. Next, the segmentation instructions may request the operating system to store the large-radix segments in one or more data structures in memory, such as arrays, dynamic arrays, linked lists, stacks, queues, etc.

In U.S. Pat. No. 6,546,411 B1, the radix 100 numbering system is used for inventing a High-Speed Radix 100 Parallel Adder. This reference is directed to integer arithmetic, not floating-point arithmetic. In integer arithmetic, there is no exponent field, no fractions, no exponent logic, no alignment, no normalization, and no rounding logic.

In the publication entitled “Revisiting the Newton-Raphson Iterative Method for Decimal Division” by Mario P. Vestias and Horacio C. Neto (Sep. 5-7, 2011), the focus is on faster decimal division, using the Newton-Raphson iterative method. In this publication, the implementation converts 3 BCD digits into a 10-bit DPD (Densely Packed Decimal used in IEEE 754-2008). In the paper, the implementation converts a 20-bit binary number to radix-1000 (FIG. 4) then uses an inefficient ripple-carry radix-1000 adder (FIG. 5).

In contrast to the publication by Vestias and Neto, as will be explained further hereinbelow, the present invention does not do any division, but only addition and subtraction. The invention does not use BCD or DPD, but only BCK (Binary Coded 1000 values). The invention does not convert binary numbers, and instead uses a much more efficient Radix-1000 adder/subtractor for adding and subtracting fractions.

The publication entitled “Floating Point Number Format with Number System with Base of 1000”, IBM Technical Disclosure Bulletin (1998) describes floating-point numbers with a base of 1000 (instead of 2) and discloses that the format is superior to Binary Code Decimal (BCD). In contrast to the present invention, there is no representation of the Radix-1000 floating-point numbers and no implementation of Radix-1000 floating point units. Rather, this publication goes the opposite direction and implements decimal floating-point units based on Radix 10, BCD, and DPD, with a much more complex representation and implementation.

### SUMMARY OF THE INVENTION

In one aspect the present invention is directed to a system, structure and method using radix-1000 (instead of radix-10) to represent and operate on decimal floating-point numbers. Instead of using a 10-bit declet to encode a DPD, this invention uses a declet to encode a BCK (Binary Coded 1000 values), where the letter K is the abbreviation of the number 1000. This invention also uses a skewed representation of the fraction field to avoid the loss of decimal digits in arithmetic operations when shifting and rounding the fraction are required.

A minor drawback of radix-1000 is the loss of a BCK digit, or three BCD digits, when incrementing the exponent field by 1 (right-shifting the significand by 10 bits). This is the case when adding/subtracting two radix-1000 floating-point numbers that have different exponent values. This is also the case when a carry is obtained, and shifting and rounding are necessary. A difference of 1 in the radix-1000 exponent is equal to a difference of 3 in the radix-10 exponent. To alleviate this drawback, this invention uses a skewed representation of the fraction field.

The present invention is further directed to a processing circuit comprising logic circuitry that performs radix 1000 decimal floating-point arithmetic. Among the features of the present invention, the logic circuitry operates on operands having a sign bit, an exponent field representing an exponent on a 1000 base and a fraction field representing a number having an absolute value that is less than one. The fraction field comprises a plurality of declets representing the numbers 0-999 and a format indicator. The logic circuitry performs the radix 1000 decimal floating-point arithmetic using one of a plurality of skewed representations of operands as indicated by the format indicator. In addition, the logic circuitry includes expansion circuitry that expands the fraction field F[115:0] into its number representation X[119:0] according to:

fmt[1:0]=F[115:114]
if fmt[1:0]=11 then X[119:117]=F[5:3] else X[119:117]=000;
if fmt[1]=1 then X[116:114]=F[2:0] else X[116:114]=concat{0,0,F[114]};

### X[113:6]=F[113:6];

if fmt[1:0]=11 then X[5:3]=000 else X[5:3]=F[5:3];
if fmt[l]=1 then X[2:0]=000 else X[2:0]=F[2:0], wherein fmt[1:0] is the format indicator.

Further features of the present invention include a special sub-circuit of the processing sub-circuit that is used for the Addition and Subtraction of radix-1000 expanded fractions.

Another feature of the present invention is a Normalize sub-circuit that may include a special sub-circuit that does the normalization of the radix-1000 result fraction. The normalization process is conditional and depends on whether the input fractions are normalized or not.

As another feature, in a Round sub-circuit, a radix-1000 normalized fraction is rounded according to the rounding mode and the normalized fraction format.

As another feature, in a Pack sub-circuit, a radix-1000 rounded fraction is packed according to its final format.

As an even further feature, in an Exception handler sub-circuit, arithmetic on special Overflow or Invalid values produces special Overflow or Invalid results. This feature also includes the ability to detect and produce an Overflow result when the normalized exponent value becomes too large. It also includes the ability to produce an Inexact flag when the produced radix-1000 fraction is rounded or truncated.

In contrast to the prior art as discussed above, even the revised IEEE 754-2008 standard uses Radix 10 for representing decimal floating-point numbers and for decimal floating-point arithmetic. IBM has implemented Radix-10 Floating-point units inside their recent processors. In contrast, as will be explained further hereinbelow, the present invention introduces a novel representation of FLOATING-POINT numbers based on radix-1000 and a SKEWED representation of the fraction. The invention also presents detailed implementation of floating-point arithmetic units that can be of various sizes (32-bit, 64-bit, and 128-bit).

These and other features, functionalities and objectives are attained with, for example, a method and system for executing a machine instruction in a central processing unit comprising circuitry.

### BRIEF DESCRIPTION OF THE DRAWINGS

The present invention is illustrated in the accompanying drawings, wherein:

FIG. 1 illustrates an example decimal interchange floating-point format according to the IEEE 754-2008 standard;

FIG. 2 illustrates an example Radix-1000 decimal floating-point interchange format according to the present invention;

FIG. 3 shows a 128-bit Radix-1000 DFP Unit according to the present invention;

FIG. 4 shows an exponent difference block diagram according to the present invention;

FIG. 5 shows a right-shifter block diagram according to the present invention;

FIG. 6 shows a fraction Add/Subtract block diagram according to the present invention;

FIG. 7 shows a Normalize block diagram according to the present invention;

FIG. 8 shows a Round block diagram according to the present invention; and

FIG. 9 shows a Packing the Result Fraction according to the present invention;

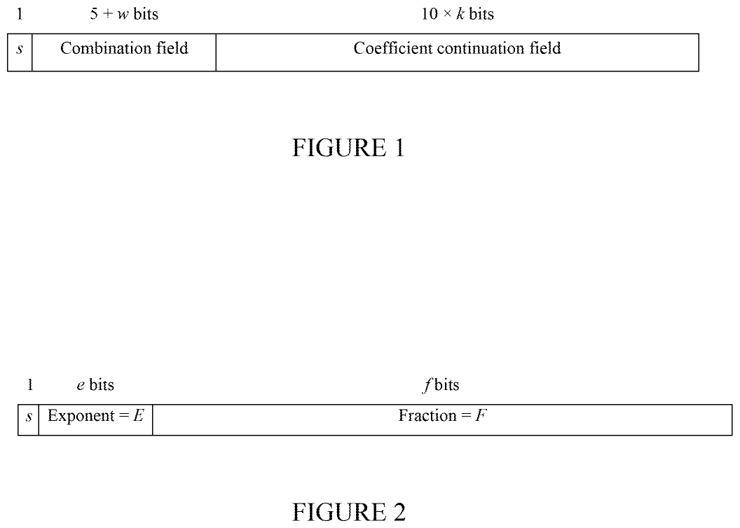

### DETAILED DESCRIPTION OF THE INVENTION

The embodiments of the present invention will be described hereinbelow in conjunction with the above-described drawings. This invention uses radix-1000 (instead of radix-10 as done in the prior art) to represent and operate on decimal floating-point numbers. It is a deviation from the IEEE 754-2008 standard. Instead of using a 10-bit declet to encode a DPD, this invention uses a declet to encode BCK (Binary Coded 1000) values, where the letter K is the abbreviation of the number 1000. The advantages of using radix-1000 are many as outlined below:
1—It is related to radix-10. Each BCK digit is equivalent to three BCD digits. Decimal fractions that can be represented exactly in radix-10 can also be represented exactly in radix-1000.
2—BCK digits are simpler than DPD. The coding efficiency is the same (97.7%). However, unlike DPD, there is no need to unpack and then pack BCK digits.
3—Internally, a radix-10 floating-point unit uses BCD digits, whereas a radix-1000 floating-point unit uses BCK digits. For example, a 128-bit decimal floating-point unit requires as many as 36 BCD digits (144 bits) for its internal representation, including BCD digits for guard and rounding [5]. On the other hand, a radix-1000 floating-point unit requires only 12 BCK digits (120 bits) for its internal representation, which is far more efficient.
4—A simpler shifter is required to aligning the BCK digits in radix-1000 because there are at most 12 BCK digits to shift in the case of addition or subtraction, while a more complex shifter is needed to align the BCD digits in radix-10.
5—A smaller binary adder is required to add the 12 BCK digits (120 bits) in radix-1000, while a larger one is needed to add the 36 BCD digits (144 bits) in radix-10.

The potential drawback of radix-1000 is the loss of a BCK digit, or three BCD digits, when incrementing the exponent field by 1 (right-shifting the significand by 10 bits). This is the case when adding/subtracting two radix-1000 floating-point numbers that have different exponent values. This is also the case when a carry is obtained, and shifting and rounding are necessary. A difference of 1 in the radix-1000 exponent is equal to a difference of 3 in the radix-10 exponent. To alleviate this drawback, this invention uses a skewed representation of the fraction field.

### A New Radix-1000 Floating-Point Interchange Format:

The radix-1000 floating-point interchange format according to the present invention consists of three fields: a sign bit s, a biased exponent field E with e bits, and a fraction field F with f bits, as shown in FIG. 2. This format is simpler than the IEEE format that uses a combination field and a trailing coefficient field. The numeric value of the radix-1000 Decimal Floating-Point (DFP) number is (−1)^{s}×0·F×1000^{E-Bias}.

In this invention, DFP32, DFP64, and DFP128 are the names of the suggested radix-1000 DFP numbers. Only a few bits are needed for the exponent field, leaving the remaining bits for the fraction field. The biased exponent range is 0 to 2-2. The Bias is equal to 2^{e}−1. The maximum exponent scale factor is 1000^{+Bias}=10^{+3×Bias} and the minimum is 1000^{-Bias}=10^{-3×Bias}. Table 1 shows the suggested parameters of the DFP32, DFP64, and DFP128 numbers. The length of the exponent and fraction fields can be chosen differently, depending on whether a wider exponent range or a higher precision is desired. The special exponent value E=2^{e}−1 is reserved for infinity and NaN. When E=2^{e}−1, the most significant bit of F specifies whether the number is infinity or NaN.

TABLE 1
Suggested Radix-1000 Decimal
Floating-Point Parameters

| Radix-1000 | | | |
|---|---|---|---|
| DFP Number | DFP32 | DFP64 | DFP128 |
| Format length | 32 bits | 64 bits | 128 bits |
| Sign | 1 bit | 1 bit | 1 bit |
| Exponent field | 6 bits | 8 bits | 11 bits |
| (e bits) | | | |
| Fraction field | 25 bits | 55 bits | 116 bits |
| (f bits) | | | |
| Biased | E = 0 to | E = 0 to | E = 0 to |
| exponent range | 62 | 254 | 2046 |
| Bias = 2^{e-1} − 1 | 31 | 127 | 1023 |
| Max Scale = | 1000⁺³¹ = | 1000⁺¹²⁷ = | 1000⁺¹⁰²³ = |
| 1000^{+Bias} | 10⁺⁹³ | 10⁺³⁸¹ | 10⁺³⁰⁶⁹ |
| Min Scale = | 1000⁻³¹ = | 1000⁻¹²⁷ = | 1000⁻¹⁰²³ = |
| 1000^{-Bias} | 10⁻⁹³ | 10⁻³⁸¹ | 10⁻³⁰⁶⁹ |
| Maximum | 7+ digits | 16+ digits | 34+ digits |
| Precision | | | |
| Numeric value | ±0.F × | ±0.F × | ±0.F × |
| | 1000^{E-3} | 1000^{E-127} | 1000^{E-1023} |

### Radix-1000 Fraction Field

The simplest representation of the fraction field F is to split the field into 10-bit declets, starting at the least-significant fraction bit and moving backwards. Each 10-bit declet is a BCK digit that encodes three decimal digits in binary (000 to 999). Since the fraction field is not multiple of 10 bits, the upper bits of the fraction field encode fewer than 1000 decimal values. This fixed-format representation of the fraction field F is shown in Table 2. The maximum precision for DFP32, DFP64, and DFP128 are 7+, 16+ and 34+ decimal digits, respectively. The + means that the precision can exceed 7, 16 and 34 digits in some limited cases.

TABLE 2
Fixed-Format Representation of the Radix-1000 Fraction

| DFP32 | 25 bits = 5b, 10b, 10b |
|---|---|
| | Max F = 0.031, 999, 999 |
| DFP64 | 55 bits = 5b, 10b, 10b, 10b, 10b, 10b |
| | Max F = 0.031, 999, 999, 999, 999, 999 |
| DFP128 | 116 bits = 6b, 10b, 10b, 10b, 10b, 10b, 10b, |
| | 10b, 10b, 10b, 10b, 10b |
| | Max F = 0.063, 999, 999, 999, 999, 999, 999, |
| | 999, 999, 999, 999, 999 |

Although the fixed-format representation of the radix-000 fraction F is the simplest to implement in hardware, its major drawback is the loss of precision when converting a radix-10 decimal number into radix-1000 or when shifting and rounding the result of an arithmetic operation. Because right-shifting is done by multiples of 10 bits, the actual precision is a variable. It varies between 5 and 7+ for DFP32, between 14 and 16+ for DFP64, and between 32 and 34+ decimal digits for DFP128.

### A Skewed Representation of the Fraction Field

To remedy the loss of precision, Table 3 shows a two-format skewed representation of the fraction F. The maximum decimal values of the two-format representation of the fraction are denoted as Max F0 and Max F1. The actual precision of the two-format representation of F is now improved. It is 6 to 7+ decimal digits for DFP32, 15 to 16+ decimal digits for DFP64, and 33 to 34+ decimal digits for DFP128.

TABLE 3
Two-Format Skewed Representation of
the Radix-1000 Fraction

| DFP32 | Max F0 = 0.015, 999, 999 |
|---|---|
| | Max F1 = 0.999, 999, 9 |
| DFP64 | Max F0 = 0.015, 999, 999, 999, 999, 999 |
| | Max F1 = 0.999, 999, 999, 999, 999, 9 |
| DFP128 | Max F0 = 0.047, 999, 999, 999, 999, 999, 999, |
| | 999, 999, 999, 999, 999 |
| | Max F1 = 0.999, 999, 999, 999, 999, 999, 999, |
| | 999, 999, 999, 999, 9 |

Since there are three decimal digits in each BCK, it is better to have a three-format skewed representation of the fraction F. Table 4 shows a three-format representation of the DFP32, DFP64, and DFP128 fractions with maximum decimal values: Max F0, Max F1, and Max F2. The actual precision is 7, 16, and 34 decimal digits for DFP32, DFP64, and DFP128, respectively.

TABLE 4
Three-Format Skewed Representation of
the Radix-1000 Fraction

| DFP32 | Max F0 = 0.009, 999, 999 |
|---|---|
| | Max F1 = 0.099, 999, 99 |
| | Max F2 = 0.999, 999, 9 |
| DFP64 | Max F0 = 0.009, 999, 999, 999, 999, 999 |
| | Max F1 = 0.099, 999, 999, 999, 999, 99 |
| | Max F2 = 0.999, 999, 999, 999, 999, 9 |
| DFP128 | Max F0 = 0.031, 999, 999, 999, 999, 999, 999, |
| | 999, 999, 999, 999, 999 |
| | Max F1 = 0.127, 999, 999, 999, 999, 999, 999, |
| | 999, 999, 999, 999, 99 |
| | Max F2 = 0.999, 999, 999, 999, 999, 999, 999, |
| | 999, 999, 999, 999, 9 |

### Expanding the Fraction Field

The two- and three-format skewed representations of the fraction field are simple to implement. The fraction F is expanded from 25 to 30 bits for DFP32, from 55 to 60 bits for DFP64, and from 116 to 120 bits for DFP128. The format is defined according to the upper bits of the fraction field. Only the upper and lower BCKs of the fraction field are expanded. The middle BCKs are not modified.

Consider the DFP128 three-format fraction, shown in Table 4. Let F_{[115:0]} be the 116-bit fraction, where bit 115 is the most significant and bit 0 is the least-significant. The format fat is defined according to the two most-significant bits of the fraction: fmt_{[1:0]}=F_{[115:114]}. Let X_{[119:0]} be the 120-bit expanded fraction for DFP128. It consists of 12 BCK digits, equivalent to 36 decimal digits. The expansion logic is described in Table 5. There are three formats to expand. If fmt_{[1]} is 8 then X_{[119:0]}={5′b0, F_{[54:0]}}, where { } is the concatenation operator and the upper 5 bits of X are zeros. Second, if fmt_{[1:0]} is 2′b10 then X_{[119:0]}={3′ b0, F_{[2:0]}, F_{[113:10]}, F_{[9:3]}*10}. The 7-bit F_{[9:3]} is multiplied by 10. This requires an adder to compute the least-significant BCK as a shifted addition. Third, if fmt_{[1:0]} is 2′ b11 then X_{[119:0]}={F_{[5:0]}, F_{[113:0]}, F_{[9:6]}*100}. The 4-bit F_{[9:3]} is multiplied by 100 that can be implemented with simple logic.

The expansion logic can be further simplified by multiplying the 7-bit F_{[9:3]} by 8 or the 4-bit F_{[9:6]} by 64, as shown in Table 5b. The least-significant BCK is computed as: X_{[9:0]}={F_{[9:3]}, 3′b6}, or {F_{[9:6]}, 6′b9}, or F_{[9:0]}. This eliminates the need to multiply by 10 or 100. A second advantage is simplifying the rounding logic. Rather than dividing the least-significant BCK of the result by 10 or 100 in the rounding step, division by 8 or by 64 becomes trivial. Packing the result fraction also becomes trivial. Multiplying F_{[9:3]} by 8 generates 125 valid BCK values (000 to 992), while multiplication by 10 generates only 100 values (000 to 990). Similarly, multiplying F_{[9:6]} by 64 generates 16 valid BCK values (000 to 960), while multiplication by 100 generates only 10 values (000 to 900). Therefore, multiplication by 8 and 64 provides a better granularity for the least-significant BCK, which is preferably rounded for inexact arithmetic results.

TABLE 5
Logic for expanding the DFP128 three-format fraction into 12 BCK digits

a) Expansion Logic using Multiplication by 10 and 100 for the least-
significant BCK

| | |
|---|---|
| fmt_{[1:0]} = F_{[115:114]} | // 2-bit format |
| X_{[119:117]} = (fmt_{[1:0]} == ' b11) ? F_{[5:3]} : 3 'b0 | // Either F_{[5:3]} or zeros |
| X_{[116:114]} = (fmt_{[1]} == 1) ? F_{[2:0]} : {0, 0, F_{[114]}} | // Either F_{[2:0]} or |
| {0,0,F_{[114]}} | |
| X_{[113:10]} = F_{[113:10]} | // No change in 104 bits |
| X_{[9:0]} = (fmt_{[1:0]} == ' b11) ? F_{[9,6]} * 100 : | // Either F_{[9:6]} * 100, or |
| . (fmt[1:0] == ' b10) ? F_{[9:3]} * 10 : F_{[9:0]} | // F_{[9:3]} * 10, or F_{[9,0]} |

b) Simpler Expansion Logic using Multiplication by 8 and 64 for the least-
significant BCK

| | |
|---|---|
| fmt_{[1:0]} = F_{[115:114]} | // 2-bit format |
| X_{[119:117]} = (fmt[1:0] == ' b11) ? F_{[5:3]} : 3 ' b0 | // Either F_{[5:3]} or zeros |
| X_{[116:114]} = (fmt[i] == 1) ? F[2:0] : {0, 0, | // Either F_{[2:0]} or |
| F_{[114]}} | |
| {0, 0, F_{[114]}} | |
| X_{[113:6]} = F_{[113:6]} | // No change in 108 bits |
| X_{[5:3]} = (fmt_{[1:0]} == 'b11) ? 3 ' b0 : F_{[5:3]} | // Either zeros or F_{[5,3]} |
| X_{[2:0]} = (fmt_{[1]} == 1) ? 3' b0 : F_{[2:0]} | // Either zeros or F_{[2:0]} |

The three-format fraction representation of DFP32 and DFP64 is slightly more complex to expand. The upper 5 bits of the fraction (with 32 possible values) specify three different formats multiplied by the ten decimal digits. Multiplication by 10 and 100 is necessary for the least-significant BCK only.

### Normalized Radix-1000 Fraction Field

Unlike binary floating-point numbers which must be normalized, decimal floating-point numbers need not be according to the IEEE 754-2008 standard. This means that a decimal number can have multiple representations, called cohorts. For example, the decimal number 0.2 can be represented using different integer coefficients as: 2×10⁻¹, 20×10⁻², 200×10⁻³, etc. All of these are equivalent representations according to IEEE 754-2008. The drawback of cohorts is the additional complexity added to the hardware implementation when adding or subtracting decimal floats. Given two decimal numbers A and B with exponents EA and EB, the preferred exponent of the result is min(EA, EB) for addition and subtraction according to IEEE 754-2008. One coefficient is left-shifted to decrease its exponent (according to the number of leading zeros) and the other coefficient is right-shifted to increase its exponent to match the exponent of the left-shifted coefficient.

To alleviate the problem of multiplicity of representation and to simplify the implementation, the radix-1000 fraction field should be normalized. This means that the largest fraction and the smallest exponent value should be used. The most-significant BCK digit in the fraction field F should be non-zero. For example, the decimal number 0.2 should be represented uniquely as: 0.200,000, . . . ×1000⁰. The only exception is Zero, which cannot be normalized. The exact number Zero is represented uniquely with E=F=0.

If a fraction is not normalized, it indicates the loss of significant digits. For example, the number 0.000,200,000, . . . ×1000¹ is not normalized. It can be approximated, but not exactly equal to 0.2. The precision is counted starting at the most-significant nonzero digit. If a number is not normalized then its fraction cannot be left-shifted and normalized, because what comes after the least-significant fraction digit is unknown (not necessarily zero). Therefore, there is no left-shifting of a radix-1000 fraction field when it is not normalized. Only right-shifting is used on the fraction of the lesser exponent when adding/subtracting radix-1000 decimal floating-point numbers.

### 128-Bit Radix-1000 Floating-Point Unit

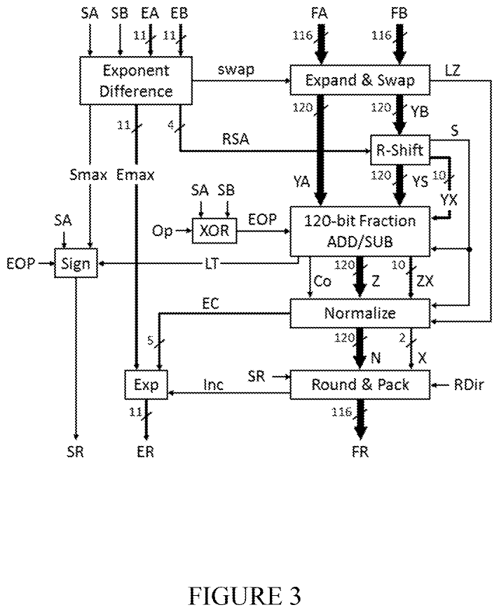

This section describes the implementation of a radix-1000 DFP128 unit 1000 that performs addition, subtraction, and comparison of radix-1000 numbers according to the present invention. The top-level design of the structure and operation of the radix-1000 DFP128 unit 1000 is shown in FIG. 3. The three-format representation is used for the 116-bit fraction F, as shown in Table 4. The precision is 34 decimal digits in all three formats but can exceed 34 in some limited cases. The radix-1000 DFP128 unit according to the invention, as well as all other units, circuits and modules, along with the blocks, functions, sub-modules and sub-circuits within the units, circuits and modules, as disclosed hereinafter, may be implemented as physical electronic circuits as would be known to those of skill in the art, or their equivalents in software or firmware.

Given two DFP128 numbers A and B, SA and SB are the input sign bits, EA and EB are the input biased exponents, and FA and FB are the input fractions of A and B, respectively, as shown in FIG. 3.

The Expand & Swap block 1002 enlarges the input fractions FA and FB from 116 to 120 bits, as described in Table 5b. The Expand logic expands only the most significant 6 bits and least-significant 6 bits of the fractions FA and FB. However, it does not modify 108 bits of FA and FB. The 120-bit expanded fractions are called XA and XB. The expanded fractions are swapped if EA<EB. The 120-bit swapped outputs are called YA and YB, where YA=swap? XB: XA and YB=swap? XA: XB.

In addition, the Expand & Swap block 1002 outputs an LZ signal that indicates whether there is a leading zero BCK in XA or XB. Only the leading BCK is examined: LZ=(XA_{[119:110]} !=0) (XB_{[119:110]} !=0). The LZ signal is used by the Normalize block 1006. If LZ is 1 then fraction FA or FB is not normalized, and the result of an arithmetic operation cannot be normalized when there are leading zeros in the result.

In contrast, the DFP accelerator on the IBM z196 unpacks the integer coefficient encoded in DPD into BCD. The unpacking logic for DPD is more complex and applies to all BCD digits. The output of the unpacker on the z196 consists of 36 BCD digits, or 144 bits, which is much longer.

The Exponent Difference block 1008 computes the difference of the 11-bit biased exponents EA and EB. It produces four outputs: swap=sign(EA−EB) is used to swap the expanded fractions XA and XB when (EA<EB), Emax is the maximum exponent value, Smax is the sign of the swapped fraction YA with exponent Emax, and RSA is the absolute difference of EA and EB that saturates at 15. RSA is a 4-bit right shift amount used by the R-Shift block 1004. Only a 4-bit shift amount is required by the right-shifter because there are only 12 BCKs in an expanded fraction, and right-shifting beyond 12 produces a zero output.

The R-Shift block 1004 right-shifts the 120-bit fraction YB according to the 4-bit right-shift amount RSA. It produces three outputs: a 120-bit shifted fraction YS, a 10-bit extra BCK YX that is shifted-out, and a sticky bit S, which is the OR-reduction of the shifted-out bits that appear after YX. The 10-bit YX and the sticky bit S are used by the 120-bit Fraction Adder/Subtractor block 1010 to compute the 120-bit result Z and its 10-bit result extension ZX.

It should be emphasized that there is no left-shifter to left-shift YA, when YA has leading zeros. As stated in the previous section, if an input fraction is not normalized then it cannot be normalized. The concept of cohorts used in the IEEE 754-2008 standard does not apply here. This simplifies the implementation.

The effective operation signal EOP is computed as: EOP=SA\hat{ }SB\hat{ }Op, where Op is the arithmetic operation select signal (ADD is 0 and SUB is 1) and \hat{ } is the XOR operation (see XOR block 1011). EOP is equal to Op if A and B have identical signs (SA is equal to SB). Otherwise, EOP=˜Op. Subtraction is also used to compare A with B.

The 120-bit fraction Add/Subtract block 1010 receives two 120-bit input fractions YA and YS, an effective operation signal EOP, a 10-bit YX BCK shifted-out by the R-shifter 1004, and a sticky bit S. It produces a 120-bit result Z, a 10-bit result extension ZX, an output carry Co, and a less than LT signal that indicates whether YA<YB. The Co signal is valid only for addition (when EOP is 0) and always 6 for subtraction. The LT signal is valid only for subtraction (when EOP is 1) and always 0 for addition. The 10-bit ZX is used as a round BCK for addition and a guard BCK for subtraction.

The Normalize block 1006 receives a 120-bit result Z, a 10-bit result extension ZX, and a carry bit Co from the fraction adder/subtractor 1010. It also receives a leading zero bit LZ from the expand unit 1002 (indicating whether FA or FB is not normalized) and a sticky bit S from the right-shifter 1004. It produces a 120-bit normalized result N, a 5-bit exponent correction EC used to compute the exponent of the result ER, and two X bits used for rounding the normalized result N.

The Sign block 1012 computes the sign of the result SR, based on the effective operation EOP, the sign bit SA, the sign bit Smax (sign of YA), and the LT signal (when EOP is subtraction).

The Round & Pack block 1014 receives a 120-bit normalized result N and two X bits from the Normalize block 1006. It also receives the result sign SR and a 2-bit round direction RDir. The 120-bit result N is normalized according to its format, and then packed into a 116-bit result fraction FR. Since rounding might produce an output carry, post-normalization is done to the rounded result in the same step. An output Inc signal indicates the presence of an output carry and is used to increment ER.

Finally, the E×p block 1018 computes and outputs the result exponent ER=Emax+EC+Inc. The 5-bit signed exponent correction EC is sign-extended and added to Emax.

### Exponent Difference

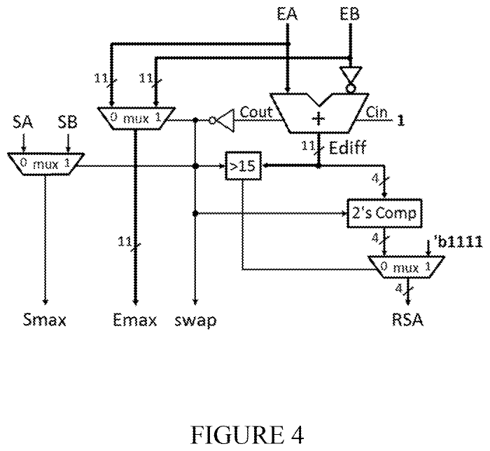

The structure and operation of the Exponent Difference block circuit 1008 are shown in FIG. 4. In this embodiment, internally, the Exponent Difference block 1008 incorporates an adder sub-block 1008a to compute the difference of the 11-bit biased exponents EA and EB: Ediff=(EA−EB)=(EA+˜EB+1). EA and EB are inputted into the adder sub-block 1008a, wherein EB is inverted when inputted into the adder sub-block 1008a. The adder sub-block 1008a outputs the 11-bit difference Ediff which is then examined via sub-block 1008b to detect whether its absolute value is >15. The >15 sub-block 1008b outputs 1 if abs(Ediff)>15, according to swap. The sign of the difference between EA and EB is the complement of the output carry: swap=sign(EA−EB)=˜Cout. Cout which is also outputted from the adder sub-block 1008a is inverted to generate swap, and then inputted into the multiplexers 1008c and 1008d. EA and EB, along with swap, are further inputted into the multiplexer 1008d to output Emax which is the maximum exponent value.

The input sign bits SA and SB, along with swap, are inputted into the multiplexer 1008c to generate Smax which is the sign of the swapped fraction YA with exponent Emax. The lower 4 bits of Ediff are further inputted into the 2's complement sub-block 1008e wherein the 2's complement is computed when the sign of the difference is negative (swap is). The lower 4 bits output of the 2's complement sub-block 1008e is inputted along with the output of the >15 sub-block 1008b and the ′b1111 signal into the multiplexer 1008f to generate RSA. RSA is the absolute difference of EA and EB that saturates at 15. RSA is a 4-bit right shift amount used by the R-Shift block 1004. Only a 4-bit shift amount is required by the right-shifter 1004 because there are only 12 BCKs in an expanded fraction, and right-shifting beyond 12 produces a zero output.

The swap signal selects Emax=max(EA, EB)=swap? EB: EA and the sign bit Smax=swap? SB: SA. Finally, the right-shift amount RSA is computed as: RSA=max(abs(Ediff), 15). It saturates at 15 when abs(Ediff)>15.

### Right Shifter

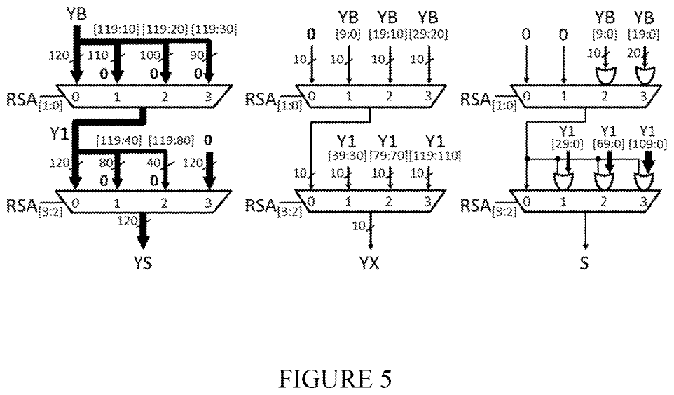

The structure and operation of the Right-Shifter block circuit 1004 is shown in FIG. 5. It uses two stages only to right-shift a 120-bit expanded fraction YB by a 4-bit right shift amount RSA. Four-way multiplexers 1018a-1018f are used to reduce the number of stages and delay in the circuit 1004. The first stage using multiplexers 1018a-1018c right-shifts the 120-bit YB by 0, 10, 20, or 30 bits, according to RSA_{[1:0]} (least-significant two bits of the shift amount). The second stage using multiplexers 1018d-1018f right-shifts the 120-bit output Y1 of the first stage by 0, 40, 80, or 120 bits, according to RSA_{[3:2]} (most-significant two bits of the shift amount), to then output the 120-bit shifted fraction YS. Zeros are inserted as upper (most-significant) bits when right-shifting.

In parallel, a 10-bit extra BCK YX is produced using also two stages (4-way multiplexers). YX is the last BCK that is shifted out according to the 4-bit shift amount RSA. It is produced from YB and Y1 as shown in FIG. 5.

In parallel, a sticky bit S is produced, which is the OR-reduction of all bits that are shifted out after the YX BCK. Large fan-in reduction OR-gates (or trees) 1020a-1020e are used to reduce the 10-bit YB_{[9:0]}, the 20-bit YB_{[19:0]}, the 30-bit Y1_{[29:0]}, the 70-bit Y1_{[69:0]}, and the 110-bit Y1_{[109:0]} into a single output bit. To minimize cost, the reduction OR-tree gates are shared. For example, |YB_{[19:0]}=(|YB_{[19:10]})| (|YB_{[9:0]}), where |YB_{[19:0]} means the reduction-OR of YB_{[19:0]}. Similarly, |Y1_{[69:0]}=(|Y1_{[69:30]})| (|Y1_{[29:0]}) and |Y_{[109:0]}=(|Y1_{[109:70]})|(|Y1_{[69:30]})|(|Y1_{[29:0]}). The output of the first-stage multiplexer 1018c is also ORed via OR-gates 1020c-1020e in the second stage into the second-stage multiplexer 1018f to determine S.

### Fraction Add/Subtract

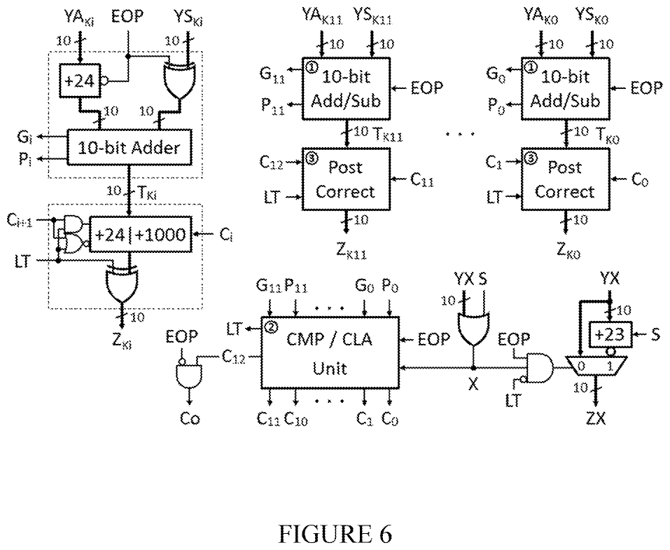

As shown in FIG. 6, in the structure and operation of the 120-bit fraction Add/Subtract block 1010, the 120-bit inputs YA and YS are split into twelve arrays of 10-bit BCKs (YA_{K0} to YA_{K11} and YS_{K0} to YS_{K11}) where YA_{K0}=YA_{[9:0]}, YA_{K1}=YA_{[19:10]}, . . . , and YS_{K0}=YS_{[9:0]}, YS_{K1}=YS_{[19:10]}, etc. Each of the 10-bit BCKs array is inputted into a corresponding one of an array of twelve 10-bit adders 1010a-1010l. Fraction addition/subtraction is done in three steps. The first step adds the twelve YA_{Ki} and YS_{Ki} BCKs in parallel using the corresponding twelve 10-bit Add/Sub sub-blocks 1022a-1022l. Within each 10-bit Add/Sub sub-block 1022n, the YA_{Ki} BCKs are each inputted into a +24 sub-block 1024 along with an inverse of the EOP bit. The YS_{Ki} BCKs are inputted into an EOR gate 1026 along with the EOP bit. The outputs of the +24 sub-block 1024 and the EOR gate 1026 are inputted into the 10-bit Adder sub-block 1028.

For addition (EOP is 0), each 10-bit Adder sub-block 1028 computes a temporary sum T_{Ki}=(YA_{Ki}+24)+YS_{Ki}. The +24 sub-block 1024 is used to skip the 24 invalid values (1000 to 1023), and adjust the sum when (YA_{Ki}+YS_{Ki})>999. For subtraction (EOP is 1), the 10-bit Adder sub-block 1028 computes T_{Ki}=YA_{Ki}+˜YS_{K1}=YA_{Ki}+1023−YS_{Ki}=(YA_{Ki}+24)+(999−YS_{Ki}). Each 10-bit Adder sub-block 1028 also produces a generate bit Gᵢ and a propagate bit Pᵢ. The generate bit Gi indicates that T_{Ki} is greater than 1023. The propagate bit Pᵢ indicates that T_{Ki} is equal to 1023. The Gᵢ and Pᵢ signals can be produced using fast logic, independently of T_{Ki}.

The second step compares the magnitudes of YA and YS when EOP is subtraction. It also produces all carries (C₀ to C₁₂) using a carry lookahead CMP/CLA unit 1034. The Group-Generate (GG) and Group-Propagate (GP) signals are defined inside the CMP/CLA unit 1034 as follows:

GG=G₁₁|(P₁₁ & G₁₀)|(P₁₁ & P₁₀ & G₉)| . . . |(P₁₁ & P₁₀ & . . . & P₁ & G₀)

GP=P₁₁ & P₁₀ & . . . & P₁ & P₀.

For subtraction, the generate and propagate signals (G₀ to G₁₁ and P₀ to P₁₁) outputted from the 10-bit Adder sub-blocks 1028 are inputted into the CMP/CLA unit 1034 and used to compare the fraction YA with YS. Given that T_{Ki}=YA_{Ki}+1023−YS_{Ki}, the generate bit G is 1 when (YA_{Ki}>YS_{Ki}). The propagate bit Pᵢ is 1 when (YA_{Ki}==YS_{Ki}). The group generate signal GG indicates whether (YA>YS). The group propagate signal GP indicates whether (YA==YS). The LT signal is defined as: LT=EOP & ˜GG & ˜GP. It is valid only for subtraction, and always zero for addition.

The carry bit Co is defined as: Co=EOP & ˜LT & ˜X, where X is the OR-reduction of all the bits that are shifted out: X=(YX !=8)+S (see OR gate 1037). Therefore, Co is 1 for subtraction (EOP is 1), when YA>=YS (LT is 0), and all the shifted-out bits are zeros (X is 0).

The twelve carries (C₀ to C₁₁) are produced in the CMP/CLA unit 1034, and depend on the value of Co, the generate bits (G₀ to G₁₁) and the propagate bits (P₀ to P₁₁). The output carry is defined as: Co=C₁₂ & ˜EOP (see AND gate 1035). It is valid only for addition (when EOP is 0). In summary, the CMP/CLA unit 1034 outputs:

$$LT = EOP \& ∼ GG \& ∼ GP = EOP \& ∼ ( GG \vert GP )$$

$${C}_{0} = EOP \& ∼ LT \& ∼ X = EOP \& ( GG \vert GP ) \& ∼ X$$

$${C}_{1} = {G}_{0} \vert ( {P}_{0} \& {C}_{0} )$$

$${C}_{2} = {G}_{1} \vert ( {P}_{1} \& {G}_{0} ) \vert ( {P}_{1} \& {P}_{0} \& {C}_{0} )$$

$$…$$

$${C}_{12} = {G}_{11} \vert ( {P}_{11} \& {G}_{10} ) \vert … \vert ( {P}_{11} \& {P}_{10} \& … \& {P}_{0} \& {C}_{0} ) = GG \vert ( GP \& {C}_{0} )$$

$$Co = {C}_{12} \& ∼ EOP$$

In parallel, the 1000's complement of YX is computed as: 1000−YX−S=˜(YX+S+23), where S is the sticky bit. The 10-bit ZX BCK is generated as either ˜(YX+S+23) or YX, depending on EOP, LT, and X. It is selected as ˜(YX+S+23) for subtraction (EOP is 1), when YA>=YS (LT is 0), and at least one of the shifted-out bits is non-zero (X is 1). Otherwise, ZX=YX. Structurally, YX is inputted directly into a multiplexer 1036 and inputted into a +23 adder sub-block 1038 that also receives the sticky bit S. The inverse of the output of the +23 adder sub-block 1038 is then inputted into the multiplexer 1036. Multiplexer 1036 also receives the output of the AND gate 1040 which is derived from the logical adding of EOP, the inverse of LT, and X. ZX is thus derived as follows:

ZX=(EOP&X&˜LT)?˜(YX+S+23):YX

The third step is to post-correct the twelve 10-bit intermediate sums (T_{K0} to T_{K11}) in parallel and compute a 120-bit result Z. Referring to FIG. 6, from the 120-bit fraction Add/Subtract block 1010, the twelve 10-bit intermediate sums (T_{K0} to T_{K11}) are each inputted into Post Correct sub-blocks 1030a-1030l. Within each Post Correct sub-block 1030n, the 10-bit intermediate sums (T_{K0} to T_{K11}) are inputted into a +24/+1000 sub-block 1032 along with the carry bit Cᵢ, the carry bit Cᵢ₊₁, and the LT bit, wherein the carry bit Cᵢ₊₁, and the LT bit are inputted into the +24/+1000 sub-block 1032 through an AND gate 1036 and through a NOR gate 1038. The output Z_{Ki} is generated from the output of the +24/+1000 sub-block 1032 inputted into an EOR gate 1040 with the LT bit.

Given a 10-bit T_{Ki}, the 10-bit post-corrected result Z_{Ki} is computed as either:

| | |
|---|---|
| Z_{Ki} = T_{Ki} +1000 + Cᵢ = T_{Ki} − 24 + Cᵢ | // when LT = 0 and Cᵢ₊₁ = 0 |
| Z_{Ki} = T_{Ki} + Cᵢ | // when LT = 0 and Cᵢ₊₁ = 1 |
| Z_{Ki} = ~(T_{Ki} + Cᵢ) = 1023 − (T_{Ki} + Cᵢ) | // when LT = 1 and Cᵢ₊₁ = 0 |
| Z_{Ki} = ~(T_{Ki} + 24 + Cᵢ) = 1023 − (T_{Ki} + 24 + Cᵢ) | // when LT = 1 and Cᵢ₊₁ = 1 |

Adding +1000 to the 10-bit sum T_{Ki} is equivalent to adding −24, because 1000=1024 (carry)−24 and the carry is ignored in the 10-bit post-correct adder. For addition, LT is always 8 and only the first two cases apply. The 120-bit result is computed as: Z=YA+YS+Co, where C₀ is always 0 for addition.

| | |
|---|---|
| Z_{Ki} = T_{Ki} − 24 + Cᵢ = YA_{Ki} + YS_{Ki} + Cᵢ | // when LT = 0 and Cᵢ₊₁ = 0 |
| Z_{Ki} = T_{Ki} + Cᵢ = (YA_{Ki} + 24) + YS_{Ki} + Cᵢ | // when LT = 0 and Cᵢ₊₁ = 1 |

For subtraction, all four cases apply as shown below. When LT is 0 (YA>=YS), the 120-bit result is computed as: Z=YA−YS−1+C₀, where C₀=˜X. Hence, Z=YA−YS when X is 0, and Z=YA−YS−1 when X is 1. When LT is 1 (YA<YS), the negative result is converted into positive and the 120-bit result is computed as: Z=YS−YA−C₀, where C₀ is always 8.

| | |
|---|---|
| Z_{Ki} = T_{Ki} − 24 + Cᵢ = YA_{Ki} + | // when LT = 0 and Cᵢ₊₁ = 0 |
| (999 − YS_{Ki}) + Cᵢ | |
| Z_{Ki} = T_{Ki} + Cᵢ = (YA_{Ki} + 24) + | // when LT = 0 and Cᵢ₊₁ = 1 |
| (999 − YS_{Ki}) + Cᵢ | |
| Z_{Ki} = 1023 − (T_{Ki} + Cᵢ) = YS_{Ki} − YA_{Ki} − Cᵢ | // when LT = 1 and Cᵢ₊₁ = 0 |
| Z_{Ki} = 1023 − (T_{Ki} + 24 + Cᵢ) = YS_{Ki} − | // when LT = 1 and Cᵢ₊₁ = 1 |
| (YA_{Ki} + 24) − Cᵢ | |

### Sign of the Result

For addition (EOP is 0), with reference to FIG. 3, the sign of the result is the sign of the first operand: SR=SA. For subtraction, the sign of the result SR=Smax\hat{ }LT, where Smax is the sign of the swapped fraction YA and LT is the output of the 120-bit fraction Add/Subtract block 1010 indicating that (YA VS). Therefore,

SR=(EOP==0)?SA:(S max\hat{ }LT).

### Normalization

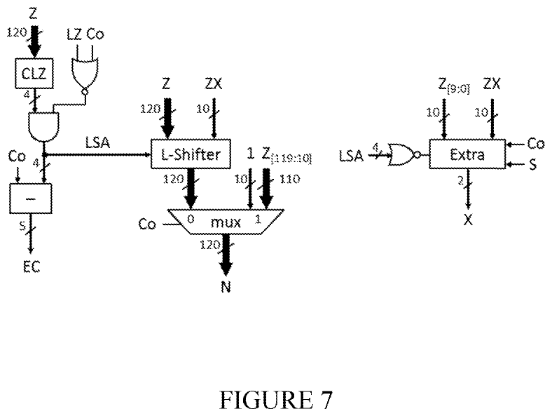

The components of the Normalize block 1006 are shown in FIG. 7. It can left-shift or right-shift its 120-bit input Z to produce a 120-bit normalized output N, wherein the 120-bit input Z, the LSA signal input and the 10-bit ZX input are entered into the L-Shifter sub-block 1042. The CLZ sub-block 1044 counts the number of leading zero-BCKs in Z and produces a 4-bit CLZ count that ranges from 0 to 12, where 12 indicates that all the 120 bits of Z are zeros. If Co and LZ inputted into the NOR gate 1046 are both zeros, then the 4-bit left-shift amount LSA=CLZ. The outputs of the CLZ sub-block 1044 and the NOR gate 1046 are inputted into an AND gate 1048 which then outputs the LSA signal. However, if Co or LZ is 1 then LSA=0. In particular, if the carry-out bit Co is 1 then Z should be right-shifted (not left-shifted). On the other hand, if the leading-zero flag LZ is 1, then it indicates that fraction FA or FB is not normalized, and hence no left-shifting can be done to Z. Co and LSA are inputted into the Subtract sub-block 1050 to generate the exponent correction EC signal.

If LSA is non-zero, the 120-bit result Z is concatenated with ZX and left-shifted via the L-Shifter sub-block 1042 and the multiplexer sub-block 1052 to produce a normalized result N. It should be noted that the left-shift amount LSA cannot exceed 1 when the fractions FA and FB are both normalized (LZ is 0) and the exponent difference is greater than 1. However, LSA can exceed 1 if the exponents EA and EB are equal or differ by at most 1, in which case the sticky bit S is always e. Therefore, the L-Shifter sub-block 1042 always inserts zero BCKs when the left shift amount LSA>1.

If the carry bit Co is 1 then Z is right-shifted 10 bits (one BCK) and the output of the L-Shifter sub-block 1042 is ignored. The exponent correction is computed as: EC=Co−LSA. It can range from −12 to +1. In summary:

LSA=˜(LZ|Co)?CLZ:8

N=(Co==S)?{Z,ZX}<<(LSA*10):{10′b1,Z_{[119:10]}}

EC=Co−LSA=Co+˜LSA+1

In parallel, the Extra sub-block 1054 receives input from to Co, S and LSA, along with Z_{[9:0]} and ZX, where LSA is inputted into Extra sub-block 1054 through the NOR gate 1056, to generate two extra bits X₁ and X₀ used for rounding N. The X₁ bit is 1 when the shifted-out BCK that appears immediately after N is greater or equal to 500. Otherwise, X₁ is 0. The shifted-out BCK can be Z_{[9:0]}, ZX, or simply zero, according to Co and LSA. The X₀ bit is the OR reduction of all bits that are shifted-out after N. The two X bits are defined by the following equations:

X₁=(Co)?(Z_{[9:0]}>=500):(LSA==0)&(ZX>=500)

x₀=(Co)?(Z_{[9:0]}!=)=(ZX!=0)|S:((LSA==0)&(ZX!=0))|S

### Rounding

This invention implements four rounding directions (RDir) defined by the IEEE 754-2008 standard:

RDir 0: Round to nearest, with ties away from zero

RDir 1: Round toward zero (truncate)

RDir 2: Round toward positive (round up)

RDir 3: Round toward negative (round down)

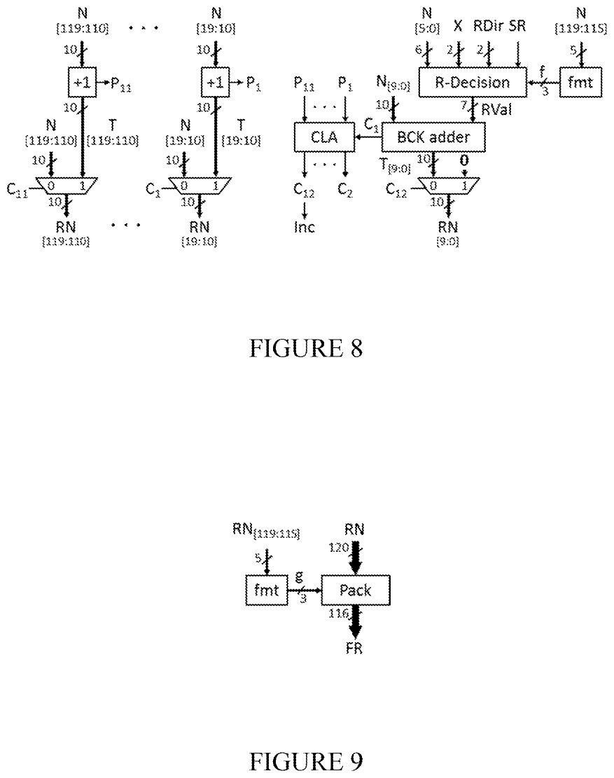

The structure and operation of Round operation of the Round & Pack block 1014 (see FIG. 3) are shown in FIG. 8. The fmt sub-block 1058 produces a 3-bit format f according to the upper 5 bits of N (N_{[119:115]}). Format f₀ is 1 if the upper BCK of N is less than or equal to 31. Therefore, f₀=˜|N_{[119:115]}, where ˜|N_{[119:115]} means the NOR-reduction of the upper five bits of N. Format f₁ is 1 if the upper BCK of N ranges from 32 to 127. Format f₂ is 1 if the upper BCK of N is greater than 127. Therefore, f₂=|N_{[119:117]}, which is the OR-reduction of the upper 3 bits of N. In summary, the fmt sub-block 1058 outputs the following three format bits:

| | |
|---|---|
| f₀ = ~\|N_{[119:115]} | // N_{[119:110]} <= 31 |
| f₁ = ~\|N_{[119:117]} & \|N_{[116:115]} | // N_{[119:110]} >= 32 && N_{[119:110]} <= |
| | 127 |
| f₂ = \|N_{[119:117]} | // N_{[119:115]} > 127 |

The R-decision sub-block 1060 generates the 7-bit round value RVal, according to the lower 6 bits of N, the two X bits, the rounding direction RDir, the sign bit of the result SR, and the 3-bit format f. The rounding values can be 0, 1, 8, or 64. The use of 8 and 64 are for formats f₁ and f₂. When rounding to nearest, the round bit can be X₁, N₂, or N₅, depending on the format f. When rounding towards positive or negative, the sticky bit can be X₀, (|N_{[2:0]} |X₀), or (|N_{[5:0]}|X₀), depending on f. The notation (|N_{[5:0]}|X₀) means the OR-reduction of the 6-bit N_{[5:0]} with X₀. The equations of RVal are presented in Table 6 hereinbelow.

| Round Direction (RDir) | Equation for RVal |
|---|---|
| 0: Round to nearest, with | RVal = (f₀ & X₁) ? 1 : |
| ties away | (f₁ & N₂) ? 8 : |
| | (f₂ & N₅) ? 64 : 0 |
| 1: Round towards zero | RVal = 0 |
| 2: Round towards positive | RVal = (f₀ & X₀ & ~SR) ? 1: |
| | (f₁ & (\|N_{[2:0]} \| X₀) & ~SR) ? 8 : |
| | (f₂ & (\|N_{[5:0]} \| X₀) & ~SR) ? 64 : 0 |
| 3: Round towards negative | RVal = (f₀ & X₀ & SR) ? 1: |
| | (f₁ & (\|N_{[2:0]} \| X₀) & SR) ? 8 : |
| | (f₂ & (\|N_{[5:0]} \| X₀) & SR) ? 64 : 0 |

Table 6: Round Value according to the round direction, format, result sign, and extra bits

The round value RVal is then inputted into the BCK adder sub-block 1062 and added to the least-significant BCK N_{[9:0]} to generate a 10-bit temporary sum T_{[9:0]}, which is computed as either (N_{[9:0]}+RVal+24) or (N_{[9:0]}+RVal) depending on whether a carry C₁ is generated or not.

C₁=(N_{[9:0]}+RVal+24)>1023

T_{[9:0]}=(C₁)?(N_{[9:0]}+RVal+24):(N_{[9:0]}+RVal)

In parallel, the upper eleven BCKs of N (N_{[19:10]} to N_{[119:110]}) are incremented independently to produce eleven output BCKs T_{[19:10]} to T_{[119:110]} and eleven propagate bits P₁ to P₁₁. Each of the 10-bit incrementer sub-blocks 1064a-1064k produces a 10-bit temporary BCK and a propagate bit P₁ as follows:

$${P}_{1} = ( {N}_{[ 19 \text{:} 10 ]} == 999 )$$

$${T}_{[ 19 \text{:} 10 ]} = ( {P}_{1} ) ? 0 \text{:} {N}_{[ 19 \text{:} 10 ]} + 1$$

$${P}_{2} = ( {N}_{[ 29 \text{:} 20 ]} == 999 )$$

$${T}_{[ 29 \text{:} 20 ]} = ( {P}_{2} ) ? 0 \text{:} {N}_{[ 29 \text{:} 20 ]} + 1 \\ … \\ {P}_{11} = ( {N}_{[ 119 \text{:} 110 ]} == 999 ) \\ {T}_{[ 119 \text{:} 110 ]} = ( {P}_{11} ) ? 1 \text{:} {N}_{[ 119 \text{:} 110 ]} + 1$$

If the propagate bit Pᵢ is 1 then the corresponding 10-bit incremented BCK is 0. The only exception is the most-significant temporary BCK T_{[119:110]}, which is 1 (not zero) if P₁₁ is asserted. This speculation means that if an output carry C₁₂ is generated and the rounded fraction is renormalized then the most significant BCK of the result will be 1. The CLA sub-block 1066 generates output carries C₂ to C₁₂, based on the values of P₁ to P₁₁ and the carry bit C₁.

$${C}_{2} = {C}_{1} \& {P}_{1}$$

$${C}_{3} = {C}_{1} \& {P}_{1} \& {P}_{2}$$

$$…$$

$${C}_{12} = {C}_{1} \& {P}_{1} \& {P}_{2} \& … \& {P}_{11}$$

$$Inc = {C}_{12}$$

Rounding and renormalization are done in one step in the Round operation. If the carry C₁₂ is 1, then the result fraction must be renormalized and the result exponent must be incremented. Therefore, Inc=C₁₂ is an output signal used to increment the result exponent. RN is defined as the 120-bit rounded and renormalized fraction. It is described with the following equations. If the carry C₁₂ is 1 then the rounded result RN is also renormalized by having RN_{[119:110]}=1 and all other BCKs (R_{[109:100]} down to R_{[9:0]}) equal to 0. In this operation, the outputs of the 10-bit incrementer sub-blocks 1064a-1064k are inputted into multiplexers 1068a-1068k, along with the carries C₁ to C₁₁ to generate the 120-bit rounded fraction RN as follows:

$${RN}_{[ 119 \text{:} 110 ]} = ( {C}_{11} ) ? {T}_{[ 119 \text{:} 110 ]} \text{:} {N}_{[ 119 \text{:} 110 ]}$$

$${RN}_{[ 109 \text{:} 100 ]} = ( {C}_{10} ) ? {T}_{[ 109 \text{:} 100 ]} \text{:} {N}_{[ 109 \text{:} 100 ]}$$

$$…$$

$${RN}_{[ 19 \text{:} 10 ]} = ( {C}_{1} ) ? {T}_{[ 19 \text{:} 10 ]} \text{:} {N}_{[ 19 \text{:} 10 ]}$$

$${RN}_{[ 9 \text{:} 0 ]} = ( {C}_{12} ) ? 0 \text{:} {T}_{[ 9 \text{:} 0 ]}$$

### Packing

The structure and operation of the Packing operation of the Round & Pack block 1014 are shown in FIG. 9. The Packing operation reduces the 120-bit rounded fraction RN into a 116-bit result fraction FR. The fmt sub-block 1070 extracts the 3-bit format g of RN according to the upper 5-bit RN_{[119:115]}. Format g₀ indicates that RN_{[119:110]} is less than or equal to 31, format g₁ indicates that RN_{[119:110]} ranges from 32 to 127, and format g₂ indicates that RN_{[119:110]} is greater than 127.

| | |
|---|---|
| g₀ = ~\|RN_{[119:115]} | // RN_{[119:110]} <= 31 |
| g₁ = ~\|RN_{[119:117]} & \|RN_{[116:115]} | // RN_{[119:110]} >= 32 && |
| | RN_{[119:110]} <= 127 |
| g₂ = \|RN_{[119:117]} | // RN_{[119:110]} > 127 |

The 3-bit format g of RN is then inputted into Pack sub-block 1072 along with the 120-bit rounded fraction RN to then output the 116-bit result fraction FR.

The Pack logic is described in Table 7. There are three formats and three ways to pack the result. If the format is g₀ then FR={0, RN_{[114:0]}}). If the format is g₁ then FR={2′b10, RN_{[113:3]}, RN_{[116:114]}} and the least-significant 3-bit FR_{[2:0]}=RN_{[116:114]}. Finally, if the format is g₂ then FR={2′b11, RN_{[113:6]}, RN_{[119:114]}} and the least-significant 6-bit FR_{[5:0]}=RN_{[119:114]}.

TABLE 7
Equations for packing the 116-bit result fraction

| | |
|---|---|
| FR_{[115]} = ~g₀ | // 0 if g₀ and 1 |
| otherwise | |
| FR_{[114]} = (g₀) ? RN_{[114]} : g₂ | // Either RN_{[114]} or g₂ |
| FR_{[113:6]} = RN_{[113:6]} | // No change in 108 |
| bits | |
| FR_{[5:3]} = (g₂) ? RN_{[119:117]} : RN_{[5:3]} | // Either RN_{[119:117]} or |
| RN_{[5:3]} | |
| FR_{[2:0]} = (g₁ \| g₂) ? RN_{[116:114]} : RN_{[2:0]} | // Either RN_{[119:114]} or |
| RN_{[2:0]} | |

### Result Exponent

The E×p block 1018, shown in FIG. 3, computes and outputs the result exponent ER=Emax+EC+Inc, where EC is a 5-bit signed exponent correction produced by the Normalize block 1006 and Inc is an increment signal produced by the Round function of the Round & Pack block 1014 indicating that the rounded result RN is also post-normalized.

There are three observations about EC and ER. The first observation is when EC is −12 then N, RN, and FR must all be zeros. This can happen in the case of subtraction, when the input fractions FA and FB are equal and normalized. However, it cannot happen if one of the input fractions FA or FB is not normalized, because left-shifting the result fraction is not allowed in that case. Therefore, if EC is −12 then ER=0.

The second observation is that if ER is incremented to 2047 then overflow occurs. In this case, the result is infinity, ER saturates at 2047, and the most-significant bit of FR must be zero.

The third observation is that if ER is decremented below 8 then underflow occurs. In this case, ER saturates at 0, and the result fraction FR is also reduced to zero.

In one embodiment, a processor of a processing environment executes instructions or code that includes one or more Floating Point Operations or calculations at least partially dependent on decimal floating-point arithmetic units. One embodiment of a processing environment to incorporate and use one or more aspects of the present invention includes, for instance, a z/Architecture® processor (e.g., a central processing unit (CPU)), a memory (e.g., main memory), and one or more input/output (I/O) devices coupled to one another via, for example, one or more buses and/or other connections (e.g., wireless).

A z/Architecture® processor is a part of a System z™ server, offered by International Business Machines Corporation (IBM®). System z™ servers implement IBM's z/Architecture®, which specifies the logical structure and functional operation of the computer. The System z™ server executes an operating system, such as z/OS®, also offered by International Business Machines Corporation. IBM® and z/OS® are registered trademarks of International Business Machines Corporation, Armonk, N.Y., USA and may rely at least partially on arithmetic representation and/or calculations that rely or include the floating decimal point arithmetic units of the present disclosure.

In another embodiment, the instruction and/or the logic of an instruction can be executed in a processing environment that is based on one architecture (which may be referred to as a “native” architecture), but emulates another architecture (which may be referred to as a “guest” architecture). In such an environment, for example, a Perform Floating Point Operation instruction and/or logic thereof, which is specified in the z/Architecture® and designed to execute on a z/Architecture® machine, is emulated to execute on an architecture other than the z/Architecture® These instructions may rely or reference, at least partially, an arithmetic representation and/or calculation that includes the floating decimal point arithmetic units of the present disclosure.

As examples, processing environment 1000 may include a Power PC® processor, a pSeries® server, or an xSeries® server offered by International Business Machines Corporation, Armonk, N.Y.; an HP Superdome with Intel® Itanium® 2 processors offered by Hewlett-Packard Company, Palo Alto, Calif.; and/or other machines based on architectures offered by IBM®, Hewlett-Packard, Intel®, Sun Microsystems or others. Power PC®, pSeries® and xSeries® are registered trademarks of International Business Machines Corporation, Armonk, N.Y., U.S.A. Intel® and Itanium® 2 are registered trademarks of Intel Corporation, Santa Clara, Calif.

A native central processing unit may includes one or more native registers, such as one or more general-purpose registers and/or one or more special purpose registers, used during processing within the environment. These registers include information that represents the state of the environment at any particular point in time and may rely or reference, at least partially, an arithmetic representation and/or calculation that includes the floating decimal point arithmetic units of the present disclosure. While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A processing circuit comprising logic circuitry for performing radix 1000 decimal floating point arithmetic; comprising:
an input fraction expanding circuit for expanding most significant bits and least significant bits of at least two input digital floating point radix-1000 inputs, the input fraction expanding circuit being configured to swap expanded fractions of the at least two digital floating point radix-1000 inputs in response to a swap signal based on the at least two input digital floating point radix-1000 inputs, thereby generating expanded fraction outputs corresponding to the at least two input digital floating point radix-1000 inputs;
an exponent difference circuit for determining a difference between biased exponents of the at least two digital floating point radix-1000 inputs in response to inputting the biased exponents and the input sign bits of the at least two input digital floating point radix-1000 inputs,
the exponent difference circuit being configured to generate at least one of a swap signal, a result exponent signal, a result sign data signal corresponding to a swapped expanded fraction data signal and a maximum exponent data signal, and right shift data signal, the swap signal being outputted to the input fraction expanding circuit to control swapping of the expanded fractions;
a right-shift circuit for right-shifting one of the expanded fraction outputs corresponding to the at least two digital floating point radix-1000 inputs in response to the right shift data signal, and for generating a sticky bit data signal and a shifted-out BCK data signal;
an add/subtract circuit for performing at least one of an adding and a subtracting computation with respect to the expanded fraction outputs to thereby generate an add/subtract result data signal;
a normalizing circuit for normalizing the add/subtract result data signal in response to the sticky bit data signal and the shifted-out BCK data signal, and generating a normalized add/subtract result data signal; and
a round and pack circuit for generating a normalized fraction output signal in response to the normalized add/subtract result data signal, the sign data signal and a round direction data signal.

2. A processing circuit according to claim 1, further comprising:
an effective operation circuit for generating an effective operation data signal in response to the input sign bits of the at least two digital floating point radix-1000 inputs and an arithmetic operation select signal, the effective operation data signal being inputted into the add/subtract circuit, wherein the add/subtract circuit performs at least one of an adding and a subtracting computation with respect to the expanded fraction outputs to thereby generate an add/subtract result data signal in response to the effective operation data signal.

3. A processing circuit according to claim 2, further comprising:
a sign circuit for determining the result sign data signal in response to at least a sign of a swapped expanded fraction data signal, a sign data signal corresponding to one of the at least two input digital floating point radix-1000 inputs, and the effective operation data signal.

4. A processing circuit according to claim 1, wherein the exponent difference circuit includes:
an adder circuit for generating the difference between biased exponents of the at least two digital floating point radix-1000 inputs and an output carry signal,
a first multiplexer circuit for generating the maximum exponent data signal,
a second multiplexer circuit for generating the sign of a swapped expanded fraction data signal in response to the input sign bits of the at least two digital floating point radix-1000 inputs and the swap signal,
a third multiplexer circuit for generating the right shift signal in response to the difference between biased exponents from the adder circuit and an absolute value determination circuit, wherein
the swap signal is outputted from the adder circuit in response to the biased exponent difference from the adder circuit.

5. A processing circuit according to claim 2, wherein the right-shift circuit includes first and second stages of multiplexers, wherein
the first stage of multiplexers are configured to generate a first stage right-shift output and a first stage right-shift last BCK output based on a second one of the expanded fraction outputs that is right-shifted in response to least significant bit data of the right shift signal,
the second stage of multiplexers are configured to generate a second stage right-shift output and a second stage right-shift BCK output based on the first stage right-shift output that is right-shifted in response to most significant bit date of the right shift signal to then generate a shifted fraction portion of the shifted-out BCK data signal,
the first stage of multiplexers are further configured to generate a first stage sticky bit data signal that is right-shifted in response to least significant bit data of the right shift signal,
the second stage of multiplexers are further configured to generate the sticky bit data signal that is right-shifted in response to most significant bit date of the right shift signal.

6. A processing circuit according to claim 5, wherein the add/subtract circuit includes
a plurality of 10-bit BCK add/subtract sub-circuits and a plurality of post-correct sub-circuits each connected to a corresponding one of the plurality of 10-bit BCK add/subtract sub-circuits, and
a carry look ahead circuit that compares magnitudes of the swapped fraction expanded fraction with the shifted-out BCK data signal to then generate a plurality of carry output data signals corresponding to each of the plurality of 10-bit BCK add/subtract sub-circuits and post-correct sub-circuits.

7. A processing circuit according to claim 1, wherein the normalizing circuit includes
an exponent correction circuit configured to generate an exponent correction signal in response to the add/subtract result data signal, a leading zero count signal, a carry-out bit signal and a leading-zero flag bit, and
a multiplexer circuit that generates the normalized add/subtract result data signal in response to the add/subtract result data signal concatenated with a result extension of the add/subtract result data signal that is left-shifted.

8. A processing circuit according to claim 1, wherein the round and pack circuit includes
a rounding decision circuit for generating a rounding value data signal in response to the normalized add/subtract result data signal and a rounding direction signal, and
a plurality of BCK incrementer circuits for generating a corresponding plurality of temporary BCK data signals and propagate bits in response to the normalized add/subtract result data signal, the plurality of BCK incrementer circuits each being configured to output 10-bit segments of a rounded normalized add/subtract result data signal.

9. A processing circuit according to claim 1, wherein each of the digital floating point radix-1000 inputs includes a fraction field comprising a plurality of declets representing numbers 0-999 and a format indicator.

10. A processing circuit according to claim 1, wherein the input fraction expanding circuit is configured to expand a skewed fraction field into an expanded representation of a fraction field F[! 15:0] into a number representation X[119:0] according to:
fmt[1:0]=F[115:114]
if fmt[1:0]=11 then X[119:117]=F[5:3] else X[119:117]=000;
if fmt[1]=1 then X[116:114]=F[2:0] else X[116:114]=concat {0,0,F[114]};
X[113:6]=F[113:6];
if fmt[1:0]=11 then X[5:3]=000 else X[5:3]=F[5:3];
if fmt[l]=1 then X[2:0]=000 else X[2:0]=F[2:0],
wherein fmt[1:0] is the format indicator.

11. A method implemented in a computer or data processing system for performing radix 1000 decimal floating point arithmetic; comprising the steps of:
inputting at least two input digital floating point radix-1000 inputs;
expanding most significant bits and least significant bits of the at least two input digital floating point radix-1000 inputs, the step of expanding including swapping expanded fractions of the at least two digital floating point radix-1000 inputs in response to a swap signal based on the at least two input digital floating point radix-1000 inputs, thereby generating expanded fraction outputs corresponding to the at least two input digital floating point radix-1000 inputs;
determining a difference between biased exponents of the at least two digital floating point radix-1000 inputs in response to inputting the biased exponents and the input sign bits of the at least two input digital floating point radix-1000 inputs;
generating at least one of a swap signal, a result exponent signal, a result sign data signal corresponding to a swapped expanded fraction data signal and a maximum exponent data signal, and right shift data signal;
inputting the swap signal to control swapping of the expanded fractions;
right-shifting one of the expanded fraction outputs corresponding to the at least two digital floating point radix-1000 inputs in response to the right shift data signal;
generating a sticky bit data signal and a shifted-out BCK data signal;
performing at least one of an adding and a subtracting computation with respect to the expanded fraction outputs to thereby generate an add/subtract result data signal;
normalizing the add/subtract result data signal in response to the sticky bit data signal and the shifted-out BCK data signal;
generating a normalized add/subtract result data signal; and
generating a normalized fraction output signal in response to the normalized add/subtract result data signal, the sign data signal and a round direction data signal.

12. A method according to claim 11, further comprising the steps of:
selecting an arithmetic operation;
generating an effective operation data signal in response to the input sign bits of the at least two digital floating point radix-1000 inputs and an arithmetic operation selection;
performing at least one of an adding and a subtracting computation with respect to the expanded fraction outputs to thereby generate an add/subtract result data signal in response to the effective operation data signal and the arithmetic operation selection.

13. A method according to claim 12, further comprising the steps of:
determining the result sign data signal in response to at least a sign of a swapped expanded fraction data signal, a sign data signal corresponding to one of the at least two input digital floating point radix-1000 inputs, and the effective operation data signal.

14. A method according to claim 11, wherein the step of determining a difference between biased exponents includes:
generating the difference between biased exponents of the at least two digital floating point radix-1000 inputs and an output carry signal,
generating the maximum exponent data signal,
generating the sign of a swapped expanded fraction data signal in response to the input sign bits of the at least two digital floating point radix-1000 inputs and the swap signal,
generating the right shift signal in response to the difference between biased exponents, wherein
the swap signal is outputted in response to the biased exponent difference.

15. A method according to claim 12, wherein the step of right-shifting circuit includes
generating via a first stage of multiplexers a first stage right-shift output and a first stage right-shift last BCK output based on a second one of the expanded fraction outputs that is right-shifted in response to least significant bit data of the right shift signal,
generating via a second stage of multiplexers a second stage right-shift output and a second stage right-shift BCK output based on the first stage right-shift output that is right-shifted in response to most significant bit date of the right shift signal;
generating a shifted fraction portion of the shifted-out BCK data signal;
generating a first stage sticky bit data signal that is right-shifted in response to least significant bit data of the right shift signal; and
generating the sticky bit data signal that is right-shifted in response to most significant bit date of the right shift signal.

16. A method according to claim 15, wherein the step of performing at least one of an adding and a subtracting computation includes
comparing magnitudes of the swapped fraction expanded fraction with the shifted-out BCK data signal to then generate a plurality of carry output data signals.

17. A method according to claim 11, wherein the step of normalizing includes
generating an exponent correction signal in response to the add/subtract result data signal, a leading zero count signal, a carry-out bit signal and a leading-zero flag bit, and
generating the normalized add/subtract result data signal in response to the add/subtract result data signal concatenated with a result extension of the add/subtract result data signal that is left-shifted.

18. A method according to claim 11, wherein the step of rounding circuit includes
generating a rounding value data signal in response to the normalized add/subtract result data signal and a rounding direction signal,
generating a corresponding plurality of temporary BCK data signals and propagate bits in response to the normalized add/subtract result data signal, and
outputting 10-bit segments of a rounded normalized add/subtract result data signal.

19. A method according to claim 11, wherein each of the digital floating point radix-1000 inputs includes a fraction field comprising a plurality of declets representing numbers 0-999 and a format indicator.

20. A method according to claim 19, wherein performing of the radix 1000 decimal floating point arithmetic uses skewed representations of operands as indicated by the format indicator.
